(19) United States
(12) Patent Application Publication
(10) Pub. No.: US 2015/0279312 A1
(43) Pub. Date: Oct. 1, 2015

(54) LCD PANEL DRIVING CIRCUIT, LCD DEVICE, AND DRIVING METHOD

(71) Applicant: SHENZHEN CHINA STAR OPTOELECTRONICS TECHNOLOGY CO., LTD., Shenzhen (CN)

(72) Inventors: Xiaoping Tan, Shenzhen (CN); Jiehui Qin, Shenzhen (CN); Yong Zhang, Shenzhen (CN)

(21) Appl. No.: 13/807,734

(22) PCT Filed: Nov. 28, 2012
(86) PCT No.: PCT/CN2012/085478

§ 371 Date: Dec. 30, 2012

(30) Foreign Application Priority Data
Nov. 27, 2012 (CN) 201210487345.5

(51) Int. Cl. G09G 5/00; G09G 3/20; G09G 5/12

(52) U.S. Cl. CPC G09G 5/006; G09G 5/12; G09G 3/2096; G09G 2350/00; G09G 2352/00; G09G 2370/12

(57) ABSTRACT

A liquid crystal display (LCD) panel driving circuit includes at least two signal input interfaces, one or more timing control circuits, a memory module, and a data processing module. When the memory module receives image data of a same display image from the signal input interfaces, the data processing module reads the image data from the memory module, the data processing module sends the image data to the one or more timing control circuits, and the one or more timing control circuits drive the LCD panel using the image data.

### TECHNICAL FIELD

The present disclosure relates to the field of a liquid crystal displays (LCD), and more particularly to an LCD panel driving circuit, an LCD device, and a driving method.

### BACKGROUND

At present, typical liquid crystal display (LCD) TV interfaces in a store include a high definition multimedia interface (HDMI) interface, a digital visual interface (DVI) interface, and a display port interface. However, for an ultra-high resolution LCD panel with a resolution of 3840×2160 or greater than 3840×2160, because of bandwidth limitations, a single-channel input that is only 30 Hz HDMI signal input interface is supported, but human eyes can observe image flicker in such a case. Therefore, double-channel input signals are a frequently-used framework. As shown in FIG. 1, by taking a DVI interface as an example, an image signal is divided into two image signals that are input into a field-programmable gate array (FPGA) by the double-channel input signals from the DVI interface. The double-channel interface signals are combined by the FPGA, the two image signals are combined, which are calculated by deviation processing, inter-row shift compensation and the like, and then are divided into two display signals. The two display signals are output to each of the timing control circuits, respectively, however, which causes non-synchronization of left and right images and affects normal image display.

### SUMMARY

In view of the above-described problems, the aim of the present disclosure is to provide a liquid crystal display (LCD) panel driving circuit, an LCD device, and a driving method thereof capable of improving the synchronization performance of the images of the LCD panel.

The aim of the present disclosure is achieved by the following technical scheme.

An LCD panel driving circuit comprises at least two signal input interfaces and one or more timing control circuits, a memory module, and a data processing module.

When the memory module receives image data of a same display image from the signal input interfaces, the data processing module reads the image data from the memory module, the data processing module sends the image data to the one or more timing control circuits, and the one or more timing control circuits drive the LCD panel using the image data.

Furthermore, there are at least two timing control circuits. The data processing module reads the image data from the memory module and processes the image data, and simultaneously sends the image data to the timing control circuits. The image data of different interfaces are stored by different storage spaces, and the image data of all the interfaces are not mutually affected. Thus, whether the image data of corresponding interfaces are written is determined by detecting whether the image data of each of the storage spaces are empty, which is a simple and reliable method, and simplifies design and reduces design cost.

Furthermore, the data processing module comprises a converting unit that converts the image data into a readable data format of the one or more timing control circuits. Because the formats of input visual signals vary, the converting unit can be added to process the data without changing the one or more timing control circuits, which reduces load of the one or more timing control circuits, and increases e generality of the one or more timing control circuits.

Furthermore, the memory module comprises at least two storage spaces, and each storage space stores the image data of one signal input interface. When each of the storage spaces is stored with the image data, the data processing module simultaneously reads the image data of each of the storage spaces, and sends the image data to the one or more timing control circuits. The image data of different interfaces are storage by different storage spaces, and the image data of all the interfaces are not mutually affected. Thus, whether the image data of corresponding interfaces are written is determined by detecting whether the data of each of the storage spaces are empty, which is a simple and reliable method, simplifies design, and reduces design cost.

Furthermore, there are at least two timing control circuits. The data processing module comprises a converting unit that converts the image data into a readable data format of the timing control circuits. The memory module comprises at least two storage spaces, and each of the storage spaces stores the image data of one signal input interface. When each of the storage spaces is stored with the image data, the data processing module simultaneously reads the image data of each of the storage spaces, and simultaneously sends the image data to all the timing control circuits when the convening unit converts the image data into the readable data format of the timing control circuits. This is a specific LCD panel driving circuit.

Furthermore, the number of the signal input interfaces are two, and the number of the storage spaces of the memory module are two as well. When the image data are input into one storage space and the first line data are written into the other storage space, the two storage spaces simultaneously begin to transmit the image data to the data processing module line by line, the data processing module converts the image data into the readable data format of the converting unit and then sends the converted image data to the one or more timing control circuits. This is a dual interface technical scheme. A mainstream dual-channel memory module (such as double data rate (DDR)) is used to store the image data.

Furthermore, the image data of the storage space are transmitted to the data processing module line by line. This is a mode of line-by-line transmission. The memory module can receive the image data from the interface module and synchronously can send the image data to the data processing module which cause high operating efficiency and increases data processing capability of the driving circuit.

Furthermore, the signal input interface is any one of a digital visual interface (DVI), a high definition multimedia interface (HDMI) and a high definition display port. The data processing module is a field-programmable gate array (FPGA). The present disclosure is widely applied to various typical data interfaces.

An LCD device comprises the aforementioned LCD panel driving circuit.

A multiple-channel signal input liquid crystal display (LCD) panel driving method, comprising: the following steps:

A. waiting for image data input from signal input interfaces of an LCD panel driving circuit, and storing the image data into a memory module of the LCD panel driving circuit;

B. going to step C when all of the signal input interfaces are stored with the same image data in the memory module. If not all of the signal input interfaces are stored with the same image data in the memory module, return to step A; and

C. driving a LCD panel when all current image data are simultaneously sent to one or more timing control circuits of the LCD panel driving circuit. Furthermore, there are at least two timing control circuits. The step A comprises: establishing a same number of storage spaces as a number of the signal input interfaces in the memory module, writing the image data of the two signal input interfaces into the corresponding storage spaces, respectively. The step B comprises: detecting content of each of the storage spaces. If contents of the two storage spaces are both not empty, going to the step C, otherwise, if contents of either of the storage space is detected to be empty, returning to step A.

The step C comprises: using a data processing module of the LCD panel driving circuit to read the image data from the memory module, convening the image data into a readable data format of the timing control circuits, and sending the image data in the readable data format to the tuning control circuits.

The image data of different interfaces are stored by different storage spaces, and the image data of all the interfaces are not mutually affected. Thus, whether the image data of corresponding interfaces are written is determined by detecting whether the data of each of the storage spaces are empty which is a simple and reliable method, simplifies design, and reduces. design cost.

Furthermore, the step C comprises: using the data processing module to read the image data from the memory module line by line, converting the image data into a readable data format of the timing control circuits, and sending the image data to all the timing control circuits. This is a mode of line-byline transmission. The memory module can receive the image data from the interface and synchronously can send the image data to the data processing module which high operating efficiency and increases data processing capability of the driving circuit.

The inventor finds that non-synchronization of the left and right, images is that: a display card or other display device may cause individual data delay because of channel speed when the display card or other display device receiving multiple-channel input, there is determined time difference between the image data, and the time difference is uncertain (a line of data or more). The FPGA may simultaneously process the data of different frames as the data of a same frame, resulting in inaccurate synchronization of left and right images, and then affecting the normal image display In the present disclosure, because of use of the memory module, the memory module stores the image data of each of the signal input interfaces in advance. When each of interfaces is stored with the image data of the same display image, the stored image data are sent to all the timing control circuits. Thus, all of the timing control circuits can receive the image data of the same display image at the same time, and simultaneously drive the existing data lines for display. Therefore, the display area corresponding to each of the timing control circuits displays corresponding images at the same time, to form a complete image, which solves a problem with images being nonsynchronous in the prior art, and increases display quality.

### BRIEF DESCRIPTION OF FIGURES

FIG. 1 is a schematic diagram of a typical liquid crystal display (LCD) panel driving circuit;

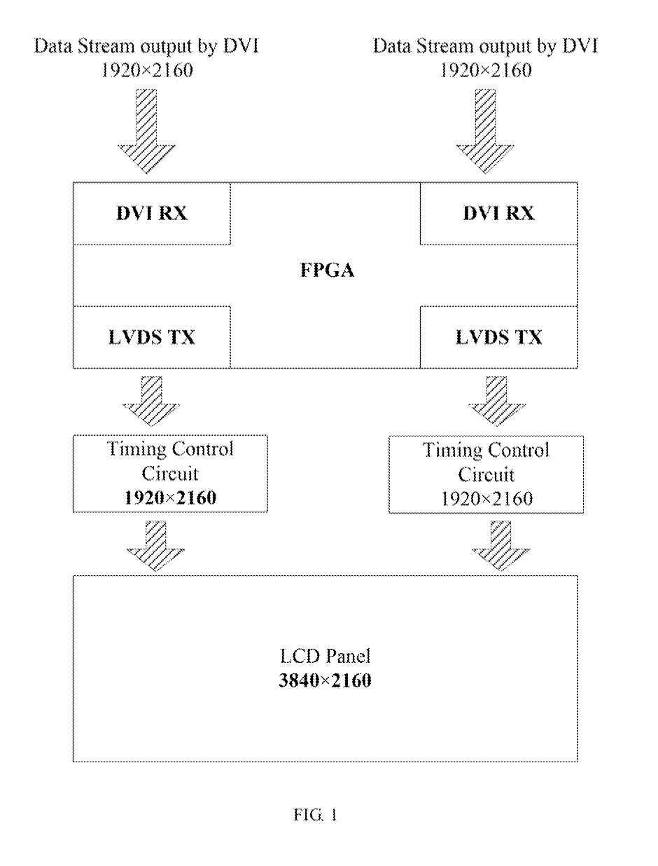

FIG. 2 is a schematic diagram of the present disclosure:

FIG. 2 is a schematic diagram of an example using dual-channel signal input of the present disclosure;

FIG. 4 is a structural diagram of data of two storage spaces of an example of the present disclosure when a double data rate (DMZ) memory module begins to store data;

FIG. 5 is a structural diagram of the data of two storage spaces of an example of the present disclosure after a DDR memory module begins to store data; and

FIG. 6 is a schematic diagram of a method of an example of the present disclosure.

### DETAILED DESCRIPTION

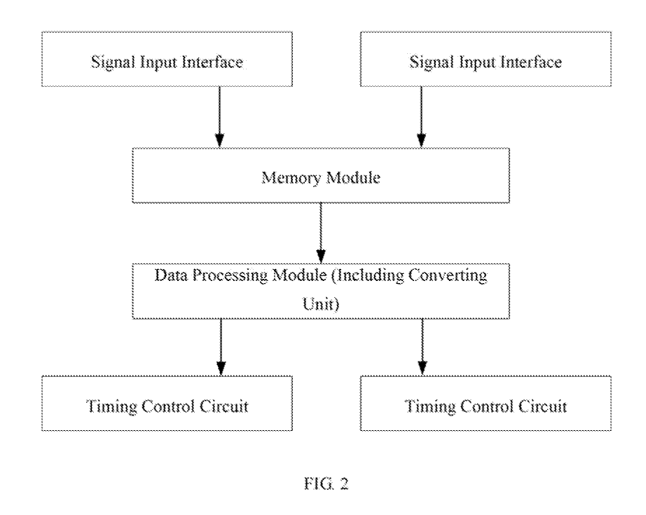

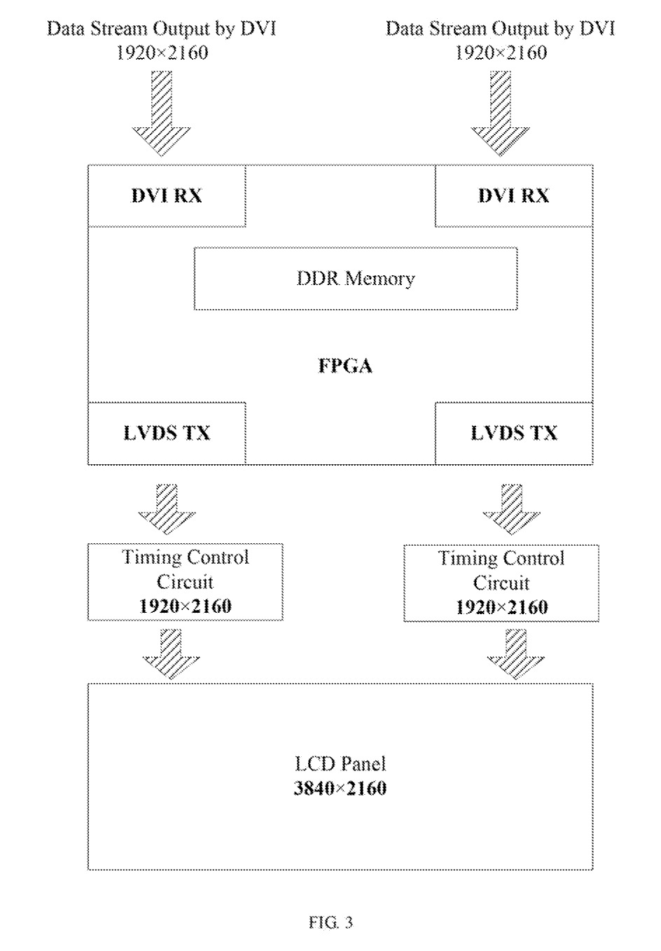

The present disclosure provides a liquid crystal display (LCD) device comprising, an LCD panel driving circuit. As shown in FIG. 2, the LCD panel driving circuit comprises at least two signal input interfaces, one or more timing control circuits, a memory module, and a data processing module.

When the memory module receives image data of a same display image from the signal input interfaces, the data processing module reads the image data from the memory module, the data processing module sends the image data to the timing control circuits, and the one or more timing control circuits drive the LCD panel using the image data.

The inventors find that there is determined time difference when a display card or other display device receives multiple-channel input image data, and the time difference is uncertain (a line of data or more), which results in non-synchronization of the left and right images, and affects normal image display. In the present disclosure, because of use of the memory module, the memory module stores the image data of each of the signal input interfaces in advance. When each of the signal input interfaces is stored with the image data of the same display image, the stored image data are sent to all the timing control circuits. Thus, all the timing control circuits can receive the image data of the same display image at the same time, and simultaneously drive existing, data lines for display. Therefore, a display area corresponding to each of the timing control circuits displays corresponding images at the same time, to form a complete image, which solves a problem with images being nonsynchronous in the prior art and improves display quality.

The data processing module comprises a converting unit that converts the image data into a readable data format of the timing control circuits. Because formats of input visual signals vary, the converting unit can be used to process data without changing the timing control circuits, which reduces load of the timing control circuits and increases generality of the timing control circuits.

The present disclosure will further be described in detail in accordance with the figures and the examples by taking the dual-channel digital visual interface (DVI) input as an example.

A 3840×2160 ultra-high definition LCD panel driving circuit comprises two DVI signal input interfaces as shown in FIG. 3. Each of the DVI signal input interfaces receives a 1920×2160 data stream, namely the half image data of the same display image, the image data corresponding to the DVI are input into a double data rate (DDR) memory module. The DDR memory module comprises two storage spaces (address 1 and address 2), and each of the storage spaces stores the image data of one DVI signal input interface.

The data processing module can be a field-programmable gate array (FPGA). When both of the storage spaces are stored with image data, the FPGA simultaneously reads the image data of each of the storage spaces and converts the image data into the readable data format of the timing control circuits, and then simultaneously sends the image data to all the timing control circuits. The image data of different interfaces are stored by different storage spaces, and the image data of all the interfaces are not mutually affected. Thus, whether the image data of corresponding interfaces are written is determined by detecting whether the image data of each of the storage spaces are empty, which is a simple and reliable method, and simplifies design and reduces design cost.

The image data of the storage spaces are transmitted to the data processing module line by line. This is a mode of line-by-line transmission. The DDR memory module can receive the image data from the interface module and synchronously can send the image data to the data processing module, which causes high operating efficiency and increases data processing capability of the driving circuit.

This example is a dual interface technical scheme. A mainstream dual-channel memory module (such as DDR) is used to store the image data. Optionally, the present disclosure is not only applicable to the digital visual interface (DVI), but is applicable to other high definition data interfaces such as high definition multimedia interface (HDMI), high definition digital display port interface and the like.

In addition to using the FPGA, the data processing module can also uses other circuits, such as data format conversion and synchronous output. Optionally, the data processing module may not include functions of the converting unit.

One DDR is added between the DVI RX and the FPGA to store the left and right image data sent by the DVI RX. Both the data received and sent by the DDR are of first in first out (FIFO), and the two different storage spaces of the DDR store two-channel DVI data (namely left and right image data), respectively.

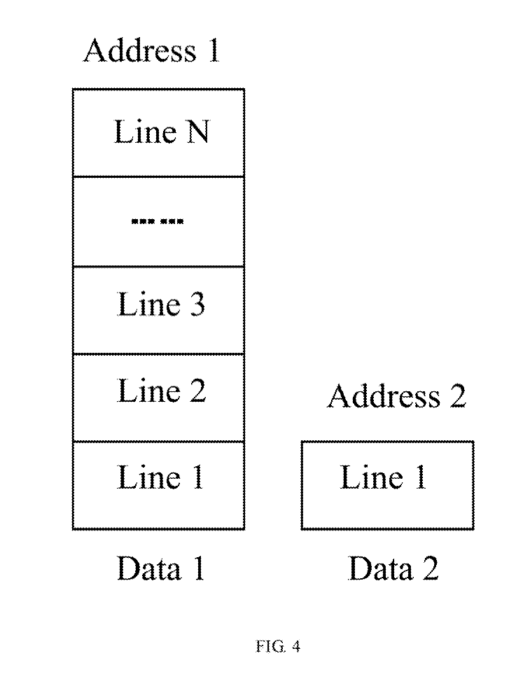

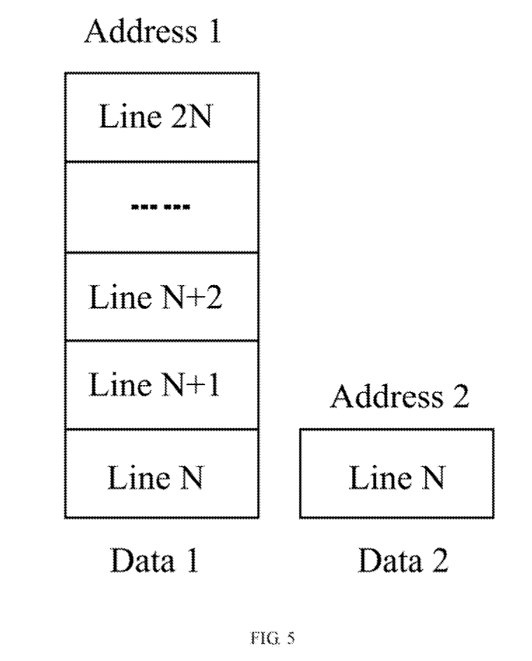

As shown in FIG. 4 and FIG. 5, suppose data 1 and data 2 represent two-channel output signals of the RX, respectively, because of a time difference of data transmission, there is a time difference from the data 1 and the data 2 to the DDR. The FPGA is used to detect whether the image data stored in the two storage spaces are empty. When the FPGA detects that both of the two storage spaces are stored with data, the DDR data are transmitted to the FPGA. For example, if the data 1 are transmitted to the DDR faster than the data 2, the DDR stores the data of data 1 all the time. To line N, when the FPGA detects that a first data of data 2 is transmitted, data 1 and data 2 are transmitted to the FPGA line by line, processed, by the FPGA and then sent to the timing control circuits, and then transmitted to the LCD panel by the timing control circuits. At the same time, data 1 and data 2 continues to be transmitted and stored into the DDR, namely sequent data that the DDR stores of data 1 is (N−1) line data more than sequent data that the DDR stores of data 2, which make images normally display and synchronized.

The present disclosure further provides a high resolution LCD panel driving method, comprising the following steps:

A. storing the image data input from each input signal interface into the memory module;

A. waiting for image data input from signal input interfaces of an LCD panel driving circuit, and storing the image data into a memory module of the LCD panel driving circuit;

B. going to step C when all of the signal input interfaces are stored with same image data in the memory module. If not all of the signal input interfaces are stored with the same image data in the memory module, return to step A;

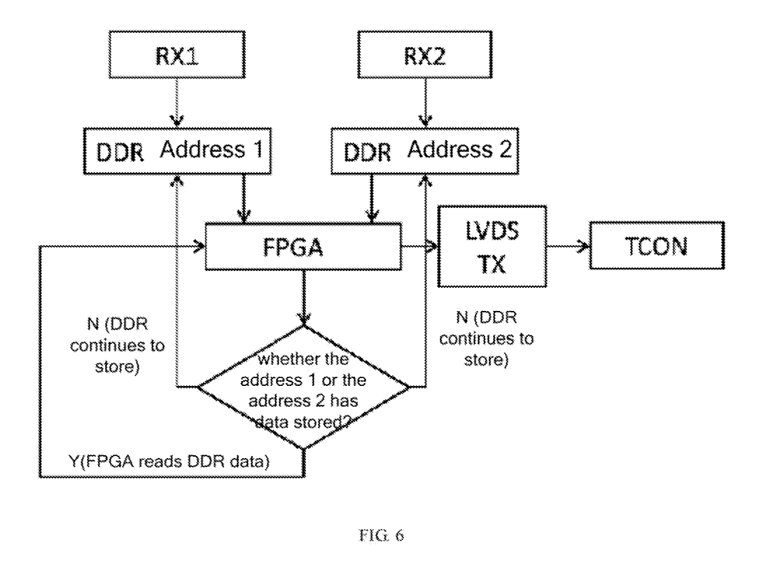

C. driving a LCD panel when all current image data are simultaneously sent to one or more timing control circuits of the LCD panel driving circuit. As shown in FIG. 6, the number of the signal input interfaces are two. The step A comprises: establishing a same number of storage spaces as a number of the signal input interfaces in a DDR memory module and writing the image data of the two signal input interfaces into the two storage spaces, respectively. The step B comprises: detecting contents of the two storage spaces, and if the contents of the two storage spaces are not empty, converting the image data into a readable data format of the timing control circuits by the FPGA, and simultaneously sending the image data to all the timing control circuits by the low voltage differential signaling TX (LVDS TX). If either storage space is detected to be empty, return to the step A to continue to store data. The image data of different interfaces are stored by different storage spaces, and the data of all the interfaces are not mutually affected. Thus, whether the image data of corresponding interfaces are written is determined by detecting whether the data of each of the storage spaces are empty, which is a simple and reliable method, and simplifies design and reduces design cost.

The FPGA reads the image data from the DDR, memory module line by line, converts the image data into the readable data format of the timing control circuits, and then sends the image data to all the timing control circuits. Thus, the DDR memory module can receive the image data from the interface module, and can synchronously send the image data to the FPGA, which causes high operating efficiency and increases data processing capability of the driving circuit.

The present disclosure is described in detail in accordance with the above contents with the specific preferred examples. However, this present disclosure is not limited to the specific examples. For the ordinary technical personnel of the technical field of the invention, on the premise of keeping the conception of the present disclosure, the technical personnel can also make simple deductions or replacements, and all of which should be considered to belong to the protection scope of the present disclosure.

1. A liquid crystal display (LCD) panel driving circuit, comprising:
at least two signal input interfaces;
one or more timing control circuits,
a memory module; and
a data processing module;
when the memory module receives image data of a same display image from the signal input interfaces, the data processing module reads the image data from the memory module, the data processing module sends the image data to the one or more timing control circuits, and the one or more timing control circuits drive the LCD panel using the image data.

2. The liquid crystal display (LCD) panel driving circuit of claim 1, wherein there are at least two timing control circuits; the data processing module reads the image data from the memory module and processes the image data, and simultaneously sends the image data to the timing control circuits.

3. The liquid crystal display (LCD) panel driving circuit of claim 1, wherein the data processing module comprises a converting unit that converts the image data into a readable data format of the one or more timing control circuits.

4. The liquid crystal display (LCD) panel driving circuit of claim 1, wherein the memory module comprises at least two storage spaces, and each of the storage spaces stores the image data of one signal input interface; when each of the storage spaces is stored with the image data, the data processing module simultaneously reads the image data of each of the storage spaces, and sends the image data to the one or more timing control circuits.

5. The liquid crystal display (LCD) panel driving circuit of claim 1, wherein there are at least two timing control circuits; the data processing module comprises a converting unit that converts the image data into a readable data format of the timing control circuits; the memory module comprises at least two storage spaces, and each of the storage spaces stores the image data of one signal input interface; when each of the storage spaces is stored with the image data, the data processing module simultaneously reads the image data of each of the storage spaces, and sends the image data to the timing control circuits.

6. The liquid crystal display (LCD) panel driving circuit of claim 1, wherein the image data of the storage spaces are transmitted to the data processing module line by line.

7. The liquid crystal display (LCD) panel driving circuit of claim 1, wherein the signal input interface is any one of a digital visual interface (DVI), a high definition multimedia interface (HDMI) or a high definition digital display interface; the data processing module is a field-programmable gate array (FPGA).

8. A liquid crystal display (LCD) device, comprising:
an LCD panel driving circuit comprising at least two signal input interfaces, one or more timing control circuits, a memory module, and a data processing module;
when the memory module receives image data of a same display image from the signal input interfaces, the data processing module reads the image data from the memory module, the data processing module sends the image data to the one or more timing control circuits, and the one or more timing control circuits drive the LCD panel using the image data.

9. The liquid crystal display (LCD) device of claim 8, wherein there are at least two timing control circuits; the data processing module reads the image data from the memory module and processes the image data, and simultaneously sends the image data to the timing control circuits.

10. The liquid crystal display (LCD) device of claim 8, wherein the data processing module comprises a converting unit that converts the image data into a readable data format of the one or more timing control circuits.

11. The liquid crystal display (LCD) device of claim 8, wherein the memory module comprises at least two storage spaces, and each of the storage spaces stores the image data of one signal input interface; when each of the storage spaces is stored with the image data, the data processing module simultaneously reads the image data of each of the storage spaces, and sends the image data to the one or more timing control circuits.

12. The liquid crystal display (LCD) device of claim 8, wherein there are at least two timing control circuits; the data processing module comprises a converting unit that converts the image data into a readable data format of the timing control circuits; the memory module comprises at least two storage spaces, and each of the storage spaces stores the image data of one signal input interface; when each of the storage spaces is stored with the image data, the data processing module simultaneously reads the image data of each of the storage spaces, and sends the image data to the timing control circuits.

13. The liquid crystal display (LCD) device of claim 8, wherein the image data of the storage spaces are transmitted to the data processing module line by line.

14. The liquid crystal display (LCD) device of claim 8, wherein the signal input interface is any one of a digital visual interface (DVI), a high definition multimedia interface (HDMI) or a high definition digital display interface; the data processing module is a field-programmable gate array (FPGA).

15. A multiple-channel signal input liquid crystal display (LCD) panel driving method, comprising the following steps:
A. waiting for image data input from signal input interfaces of an LCD panel driving circuit, and storing the image data into a memory module of the LCD panel driving circuit;
B. going to step C when all of the signal input interfaces are stored with a same image data in the memory module; if not all of the signal input interfaces are stored with the same image data in the memory module, return to step A;
C. driving an LCD panel when all of current image data are simultaneously sent to one or more timing control circuits of the LCD panel driving circuit.

16. The multiple-channel signal input LCD panel driving method of claim 15, wherein there are at least two timing control circuits; the step A comprises:
establishing a same number of storage spaces as a number of the signal input interfaces in the memory module; writing the image data of the two signal input interfaces into the corresponding two storage spaces, respectively; the step B comprises: detecting contents of the two storage spaces; if the contents of the two storage spaces are both not empty, going to the step C, if contents of either of the storage space is detected to be empty, returning to the step A;
the step C comprises: using a data processing module of the LCD panel driving circuit to read the image data from the memory module, converting the image data into a readable data format of the timing control circuits, and sending the image data in the readable data format to the timing control circuits.
